(19) United States
(12) Patent Application Publication
(10) Pub. No.: US 2021/0061267 A1
(43) Pub. Date: Mar. 4, 2021

(54) METHOD AND A DEVICE FOR OPERATING AN AUTOMATED VEHICLE

(71) Applicant: Robert Bosch GmbH, Stuttgart (DE)

(72) Inventors: Thomas Schlender, Renningen (DE); Thomas Lich, Esslingen (DE); Tino Brade, Muldestausee (DE)

(21) Appl. No.: 16/896,753

(22) Filed: Jun. 9, 2020

(30) Foreign Application Priority Data
Sep. 4, 2019 (DE) 102019213423.8

(51) Int. Cl. B60W 30/09; B60W 30/095; G08G 1/16; B60W 40/08; B60W 50/14

(52) U.S. Cl. CPC B60W 30/09; B60W 30/0956; B60W 2554/40; B60W 40/08; B60W 50/14; G08G 1/166

(57) ABSTRACT

A method and a device for operating an automated vehicle. The method includes determining a collision risk for the automated vehicle originating from a further vehicle, determining an expected collision zone on the automated vehicle as a function of the collision risk, determining a driving strategy as a function of the expected collision zone, and operating the automated vehicle as a function of the driving strategy.

### CROSS REFERENCE

The present application claims the benefit under 35 U.S.C. § 119 of German Patent Application No. DE 102019213423.8 filed on Sep. 4, 2019, which is expressly incorporated herein by reference in its entirety.

### FIELD

The present invention relates, among other things, to a method for operating an automated vehicle as a function of a driving strategy, with this driving strategy being determined as a function of an expected collision zone on the automated vehicle.

### SUMMARY

An example method according to the present invention for operating an automated vehicle includes a step of determining a collision risk for the automated vehicle that originates from another vehicle; a step of determining an expected collision zone on the automated vehicle as a function of the collision risk; a step of determining a driving strategy as a function of the expected collision zone; and a step of operating the automated vehicle as a function of the driving strategy.

An automated vehicle is to be understood as a vehicle which is developed according to one of the SAE levels 1 through 5 (see SAE J3016 standard).

A collision risk—originating from another vehicle—is a likelihood (dependent on predefined criteria) of a collision between the automated vehicle and the other vehicle, for instance as a function of a velocity and/or an acceleration and/or a steering behavior of the automated vehicle and/or the other vehicle, at the instant when the collision risk is determined. For example, the collision risk is determined in the form of a signal or in the form of data values, as “collision likely” or “collision unlikely”, in that a trajectory of the automated vehicle and/or a trajectory of the other vehicle is/are determined and their (time) characteristics in relation to each other is examined (e.g., it is examined whether the two trajectories cross in a critical area so that both vehicles will reach this critical area at the same time, which therefore leads to a collision risk “collision likely”). For example, a collision risk is determined as “collision unlikely” if the two trajectories do not drop below a predefined minimum distance (such as a few meters) or, if the two trajectories do cross in a critical area, a minimum time period (such as a few seconds) is available between the two vehicles when they reach or pass through this critical area.

An expected collision risk is to be understood as a zone of the automated vehicle that will be struck by the other vehicle during a collision.

A vehicle strategy is a driving input or control input for the automated vehicle. The determination of the driving strategy includes providing a signal (e.g., for a control device and/or for an output unit of the automated vehicle, etc.), which represents the driving strategy.

An operation of the automated vehicle, for example, is an automated transverse and/or longitudinal control and/or an execution of a safety-enhancing assistance function (belt tensioning, arming an airbag, adapting the seat position, among other things). More specifically, an operation means that the vehicle is operated in such a way that contact and/or a collision is/are avoided or the consequences of a collision for the automated vehicle or the passengers of the automated vehicle are reduced.

The example method according to the present invention advantageously achieves the objective of operating an automated vehicle in such a way that in an (almost) unavoidable collision, in particular a side collision (the expected collision zone corresponds to a side of the automated vehicle), the expected collision zone is shifted or—in the best case scenario—a collision is avoided entirely. This object is achieved by the method according to the present invention in that an expected collision zone is determined, and a driving strategy is determined as a function thereof, with the automated vehicle subsequently being operated as a function of this driving strategy. This makes it possibly to markedly reduce the accident or injury risk to affected road users. In addition, the number of multiple collisions is reduced and thus also the accident or injury risk to further potential involved parties. For example, skidding of the automated vehicle, and thus the risk of multiple collisions, is able to be avoided with the aid of the present invention in that the expected collision zone is shifted during the operation (e.g., by a longitudinal acceleration) in such a way that a collision, in particular a side collision, in the area of the lateral-guidance axle (which is the rear axis in most cases) is avoided. This is advantageous because an instability as a result of the collision in particular leads to skidding of the automated vehicle much faster than a collision in the frontal area.

The driving strategy is preferably determined as a function of a disposition of a passenger compartment of the automated vehicle.

For example, a disposition of a passenger compartment is to be understood as the relative position of the passenger compartment for the design of the automated vehicle and/or a design of the passenger compartment (length, width, height, shape, positioning or design of the seats, etc.).

This offers the advantage of reducing the accident or injury risk of possible passengers, in particular when shifting the expected collision zone away from the passenger compartment.

The driving strategy is preferably determined as a function of a distribution of passengers of the automated vehicle. For instance, this may be used to advantage for changing the expected collision zone so that as few passengers as possible are seated in the immediate vicinity of the expected collision zone.

A distribution of passengers, for example, is to be understood as the occupancy of the possible seats by passengers.

The driving strategy is preferably determined as a function of at least one further road user. At least one further road user, for example, is at least one vehicle which is driving in particular in front of and/or behind the automated vehicle in the driving direction, and/or at least one pedestrian and/or at least one bicyclist, etc. In this way, the safety of the automated vehicle or the safety of possible passengers is additionally improved in that further potential risks are taken into account.

The driving strategy preferably includes at least one acceleration-related setting change as a function of a development of a drive technology of the automated vehicle.

A design of a drive technology, for example, is to be understood as a development of the engine of the automated vehicle (internal combustion engine, electric motor, hybrid, etc.).

An acceleration-related setting change, for example, is to be understood as downshifting by at least one gear step starting from the current gear step in the case of an internal combustion engine, or as an (intermittent) operation of the motor in an overload range if an electric motor is involved. In both cases, this makes it possible for the automated vehicle to accelerate more rapidly, for instance, and thus to move more rapidly as the case may be, in such a way that a collision is avoided or the consequences of a collision are reduced.

Taking the design of the drive technology into account advantageously allows for the most optimal determination of a driving strategy, which further increases the safety of the automated vehicle and the safety of possible passengers.

The operation preferably includes an automated transverse and/or longitudinal control of the automated vehicle, in particular a deceleration, an acceleration or steering.

The operation preferably includes providing a warning signal.

For example, a warning signal is to be understood as an acoustic and/or visual and/or haptic warning, which is directed to one or a plurality of passenger(s) of the automated vehicle, with this warning being supplied or realized with the aid of a loudspeaker and/or a display and/or a vibration device (vibration-capable steering wheel, etc.), for instance.

The device according to the present invention, in particular a control unit, is developed to carry out all of the steps of the method according to one of the method claims.

In one possible embodiment of the present invention, the device includes a processing unit (processor, working memory, hard disk) as well as suitable software for executing the method. Toward this end, the device includes an interface, which is configured to sense an environment of the automated vehicle in the form of environmental data values from an (environment) sensor system of the vehicle. An acquisition of the environment data values, for example, means that the environmental data values are acquired with the aid of the sensor system and received from the sensor system with the aid of the interface. In addition, for example, the device includes an interface, which is connected to a navigation device in such a way that a trajectory of the automated vehicle is able to be requested and/or received via the navigation device. In one possible embodiment, for instance, the device additionally has an interface by which a velocity and/or an acceleration and/or further parameters are able to be requested and received. Moreover, the device includes an interface for the supply or the emission of a signal for the operation of the automated vehicle.

An (environment) sensor system of the automated vehicle is to be understood as at least one video and/or at least one radar and/or at least one lidar and/or at least one ultrasonic and/or at least one further sensor, which is/are embodied to acquire an environment of an (automated) vehicle in the form of environmental data values, with this environment in particular including a further vehicle and/or at least one further road user. Toward this end, the environment sensor system includes a processing unit (processor, working memory, hard disk) provided with a suitable software, for instance, and/or is connected to such a processing unit, so that objects in this environment (another vehicle, further road users, infrastructure features [intersection, road characteristic, traffic signs, road markings, road delimitations, curbstones, traffic lights], etc.) are able to be acquired and/or classified or allocated.

In addition, an example computer program is provided in accordance with the present invention, which includes commands which, when the computer program is executed by a computer, induces the computer to carry out a method according to the present invention. In one specific embodiment, the computer program corresponds to the software included by the device.

In addition, a machine-readable memory medium is claimed on which the computer program is stored. In one possible embodiment, the machine-readable memory medium is embodied as a neurochip or a neuromimetic chip, for instance.

Advantageous further developments of the present invention are described herein.

### BRIEF DESCRIPTION OF THE DRAWINGS

Exemplary embodiments of the present invention are shown in the figures and elucidated in greater detail below.

FIG. 1 shows an exemplary embodiment of the method according to the present invention.

FIG. 2 shows a plurality of exemplary embodiments of expected collision zones on an automated vehicle.

FIG. 3 shows an exemplary embodiment of the method according to the present invention in the form of a flow diagram.

### DETAILED DESCRIPTION OF EXAMPLE EMBODIMENTS

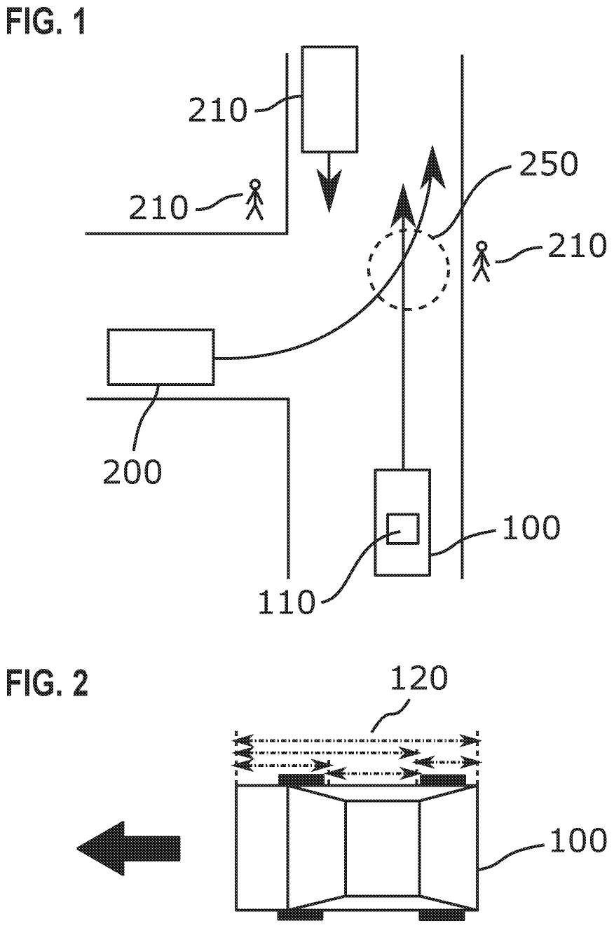

FIG. 1 shows an exemplary embodiment of a method 300 in accordance with the present invention for operating 340 an automated vehicle 100, which is equipped with a device 110 for executing method 300.

Another vehicle 200 is located in an environment of automated vehicle 100, which is detected with the aid of an (environment) sensor system of automated vehicle 100. An environment describes a detection range of the (environment) sensor system, for example.

After a further vehicle 200 has been detected, it is then determined whether a collision risk to automated vehicle 100 emanates from a further vehicle 200. Toward this end, for example, trajectories (indicated by arrows in this instance) are estimated with the aid of detectable parameters of automated vehicle 100 and detectable parameters of other vehicle 200, and a critical area 250 is determined on the basis of these trajectories.

If a collision risk does exist, an expected collision zone 120 on automated vehicle 100 is subsequently determined. Here, expected collision zone 120 is to be expected on the left rear in the driving direction, on the side of automated vehicle 100, for example.

Next, a driving strategy is determined as a function of expected collision zone 120. As a priority, a driving strategy that results in a complete avoidance of a collision is determined. If this cannot be entirely excluded according to predefined criteria, then the vehicle strategy is determined in such a way that the accident or injury risk is minimized. Toward this end, for example, automated vehicle (100) is (digitally) subdivided into vehicle zones which are correspondingly included and/or stored as data values by device 110, with these vehicle zones being weighted or evaluated according to their importance in connection with a collision. The type and manner of the weighting may be realized by way of example via the aforementioned supplementary information such as a number of passengers and/or their physical position in automated vehicle 100. By carrying out a comparison of expected collision zone 120 with the vehicle zones, for instance as a function of the previously determined trajectories and/or as a function of the aforementioned parameters etc., the best possible driving strategy, defined according to predefined criteria, is determined in that an acceleration of automated vehicle 100 is carried out in such a way, for instance, that expected collision zone 120 is shifted and a vehicle zone other than the expected collision zone comes about. In addition, in one possible embodiment, determining 330 the driving strategy is implemented as a function of at least one further road user 210.

After the driving strategy has been determined, automated vehicle 100 is operated as a function of the driving strategy.

FIG. 2 shows a plurality of exemplary embodiments of an expected collision zone 120 of automated vehicle 100. Expected collision zones 120 are shown along one side of automated vehicle 100 purely by way of example. Depending on how well or how poorly other vehicle 200 is able to be detected and/or depending on the distance and/or velocity of other vehicle 200 relative to automated vehicle 100 and/or depending on the development of the road, etc., this area may be determined in greater or less precise or smaller (more precise) form.

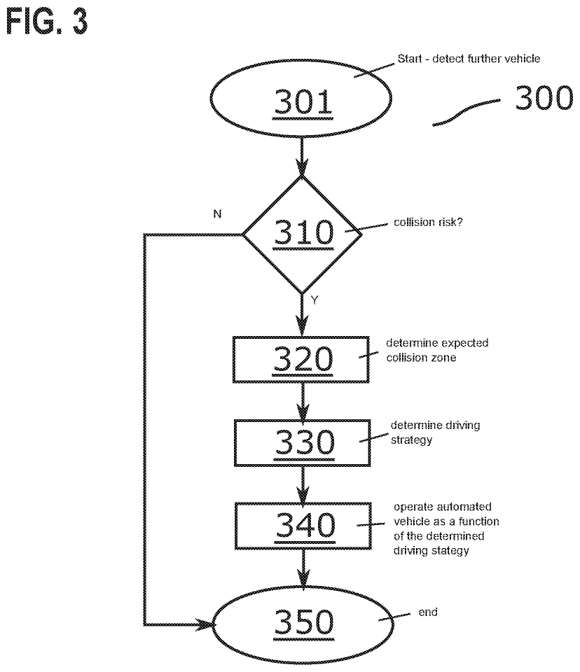

FIG. 3 shows an exemplary embodiment of a method 300 for operating 340 an automated vehicle 100.

In step 301, method 300 begins. For instance, this is achieved in that a further vehicle is detected in the environment of automated vehicle 100 with the aid of an (environment) sensor system of automated vehicle 100 and identified or determined as a vehicle, and a corresponding signal is transmitted or made available to device 110.

In step 310, a collision risk to automated vehicle 100 that originates from a further vehicle 200 is determined. If a collision risk is determined as “collision likely”, then step 320 follows. If a collision risk is determined as “collision unlikely”, step 350 follows and method 300 ends. In one possible embodiment, for example, step 310 in connection with an acquisition of the environment of automated vehicle 100 is repeated until no other vehicle 200 is able to be detected with the aid of the (environment) sensor system of automated vehicle 100.

In step 320, an expected collision zone 120 on automated vehicle 100 is determined as a function of the collision risk.

In step 330, a driving strategy is determined as a function of the expected collision zone 120.

In step 340, automated vehicle 100 is operated as a function of the driving strategy.

Method 300 ends in step 350.

What is claimed is:

1. A method for operating an automated vehicle, the method comprising the following steps:
determining a collision risk for the automated vehicle originating from a further vehicle;
determining an expected collision zone on the automated vehicle as a function of the collision risk;
determining a driving strategy as a function of the expected collision zone; and
operating the automated vehicle as a function of the driving strategy.

2. The method as recited in claim 1, wherein the driving strategy is determined as a function of a disposition of a passenger compartment of the automated vehicle.

3. The method as recited in claim 1, wherein the driving strategy is determined as a function of a distribution of passengers of the automated vehicle.

4. The method as recited in claim 1, wherein the driving strategy is determined as a function of at least one further road user.

5. The method as recited in claim 1, wherein the driving strategy includes at least one acceleration-related setting change as a function of a drive technology of the automated vehicle.

6. The method as recited in claim 1, wherein the operation includes an automated transverse control of the automated vehicle and/or longitudinal control of the automated vehicle.

7. The method as recited in claim 1, wherein the operating includes an automated deceleration of the automated vehicle or an automated acceleration of the automated vehicle.

8. The method as recited in claim 1, wherein the operation includes providing a warning signal.

9. A control device configured to operate an automated vehicle, the control device configured to:
determine a collision risk for the automated vehicle originating from a further vehicle;
determine an expected collision zone on the automated vehicle as a function of the collision risk;
determine a driving strategy as a function of the expected collision zone; and
operate the automated vehicle as a function of the driving strategy.

10. A non-transitory machine-readable memory medium on which is stored a computer program for operating an automated vehicle, the computer program, when executed by a computer, causing the computer to perform the following steps:
determining a collision risk for the automated vehicle originating from a further vehicle;
determining an expected collision zone on the automated vehicle as a function of the collision risk;
determining a driving strategy as a function of the expected collision zone; and
operating the automated vehicle as a function of the driving strategy.
